(19) United States
(12) Patent Application Publication
(10) Pub. No.: US 2026/0158623 A1
(43) Pub. Date: Jun. 11, 2026

(54) WRENCH

(71) Applicant: TECHTRONIC CORDLESS GP, Anderson, SC (US)

(72) Inventors: Shashwat Shah, Greenville, SC (US); Rony C. Chan, Simpsonville, SC (US); Drew A. Dahill, Greenville, SC (US)

(21) Appl. No.: 19/400,723

(22) Filed: Nov. 25, 2025

Related U.S. Application Data
(60) Provisional application No. 63/730,284, filed on Dec. 10, 2024.

(51) Int. Cl. B25B 13/08; B25B 13/04

(52) U.S. Cl. CPC B25B 13/08; B25B 13/04

(57) ABSTRACT

A wrench may include a first end shaped to engage a fastener. The wrench may include a second end shaped to engage the fastener, and one or both of the first end and the second end defines an open end of the wrench including an engagement section having a primary grip structure configured to grip the fastener and a secondary grip structure configured to grip the fastener after slippage of the fastener from the primary grip structure.

### CROSS-REFERENCE TO RELATED APPLICATION

This application claims priority to U.S. Provisional Patent Application No. 63/730,284, filed on Dec. 10, 2024, and entitled “Wrench”, the contents of which are hereby incorporated by reference in their entirety.

### BACKGROUND

The present disclosure relates to a hand tool and, more particularly, to a wrench. Wrenches are widely used hand tools designed to apply torque to fasteners such as nuts and bolts. Traditional open-end wrenches feature a U-shaped opening that engages two parallel faces of a fastener, allowing for quick placement and removal without fully encircling the fastener. While these designs provide convenience, they often suffer from limitations such as slippage under high torque, restricted access in confined spaces, and difficulty maintaining proper alignment during use.

### SUMMARY

There remains a need for an improved wrench configuration that enhances grip on the fastener while preserving the accessibility and speed advantages of an open-end design. Such improvements may include structural modifications to the wrench head, optimized geometry for better load distribution, or features that reduce wear and deformation of fastener surfaces during repeated use.

In some aspects, the techniques described herein relate to a wrench including: a first end shaped to engage a fastener; and a second end shaped to engage the fastener, wherein one or both of the first end and the second end defines an open end of the wrench including an engagement section having a primary grip structure configured to grip the fastener and a secondary grip structure configured to grip the fastener after slippage of the fastener from the primary grip structure.

In some aspects, the techniques described herein relate to a wrench including: a first end shaped to engage a fastener; and a second end shaped to engage the fastener, wherein the first end includes an engagement section having first surfaces configured to at least initially grip the fastener, and second surfaces recessed from the first surfaces and configured to grip the fastener after slippage of the fastener within the first end.

In some aspects, the techniques described herein relate to a wrench including: an open end shaped to engage a fastener, the open end including an engagement section having standard profile surfaces defining a primary grip structure configured to grip the fastener in a first state, the engagement section further having a set of teeth with a first tooth and a second tooth and defining a secondary grip structure configured to grip the fastener in a second state after the fastener has slipped from the first state, and the engagement section further having an island disposed adjacent to the first tooth, wherein the standard profile surfaces have a first surface and a second surface opposite the first surface and parallel to the first surface, and wherein the first tooth is disposed in the first surface and the second tooth is disposed in the second surface.

Features and aspects of the disclosure will become apparent by consideration of the following detailed description and accompanying drawings.

### BRIEF DESCRIPTION OF THE DRAWINGS

FIG. 1 is a perspective view of a wrench.

FIG. 2 is a bottom perspective view of the wrench of FIG. 1.

FIG. 3 is a front view of the wrench of FIG. 1.

FIG. 4 is a rear view of the wrench of FIG. 1.

FIG. 5 is a side view of the wrench of FIG. 1.

FIG. 6 is a side view of the wrench of FIG. 1.

FIG. 7 is a top view of the wrench of FIG. 1.

FIG. 8 is a bottom view of the wrench of FIG. 1.

FIG. 9 is a view of a first end of the wrench of FIG. 1.

FIG. 10 is a view of a first end of the wrench of FIG. 1, illustrating the wrench engaging a fastener in a first state.

FIG. 11 is a view of the first end of the wrench of FIG. 1, illustrating the wrench engaging a fastener in a second state.

FIG. 12 is a view of the first end of the wrench of FIG. 1, illustrating the wrench engaging a fastener in a third state.

FIG. 13 is an enlarged perspective view of the wrench of FIG. 1 engaging a nut.

### DETAILED DESCRIPTION

Before any examples of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

Features illustrated or described as part of one embodiment can be used with another embodiment to yield a still further embodiment. Thus, it is intended that the present invention covers such modifications and variations as come within the scope of the appended claims and their equivalents. The Detailed Description uses numerical and letter designations to refer to features in the drawings. Like or similar designations in the drawings and description have been used to refer to like or similar parts of the invention.

As used herein, the terms “first,” “second,” and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction (e.g., clockwise or counterclockwise).

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

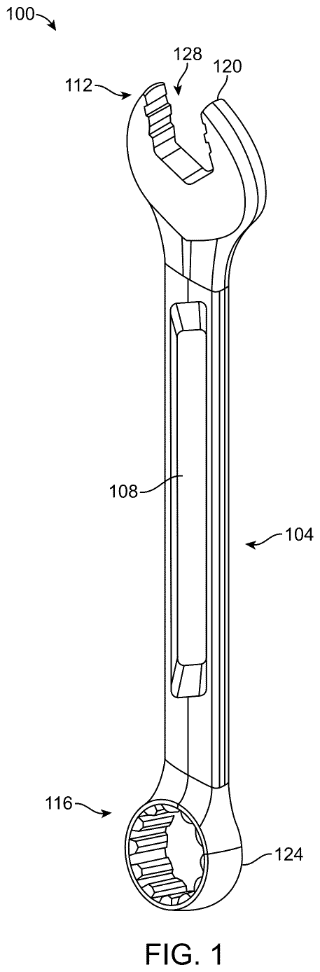

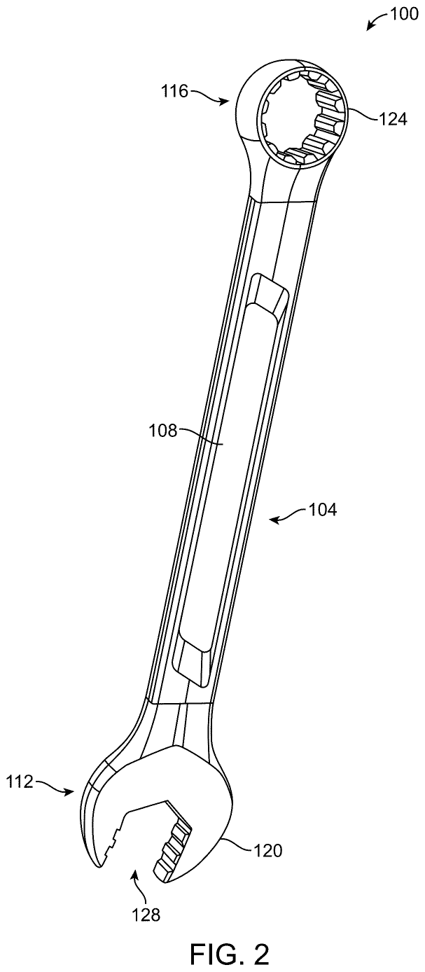

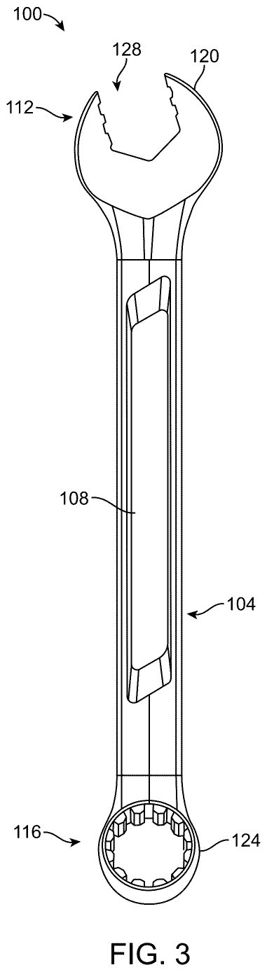

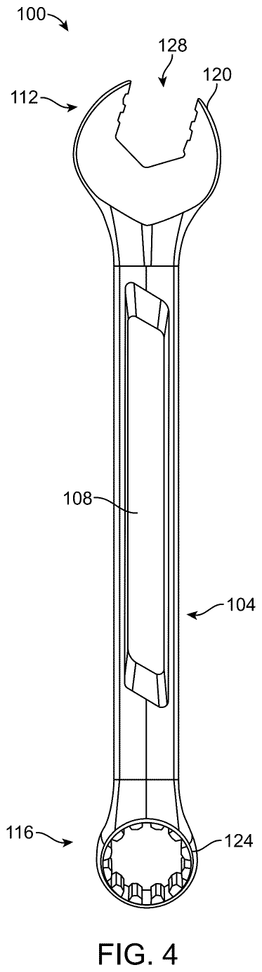

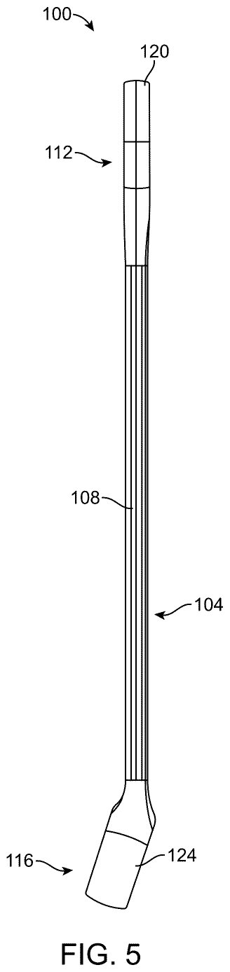

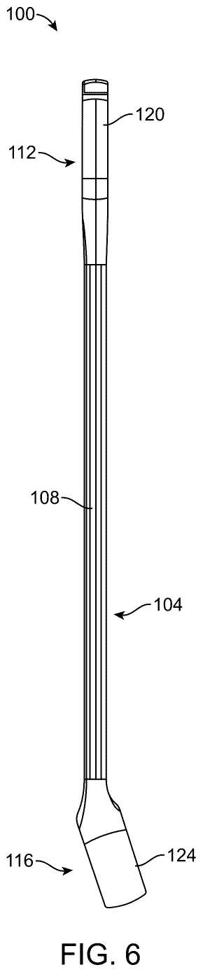

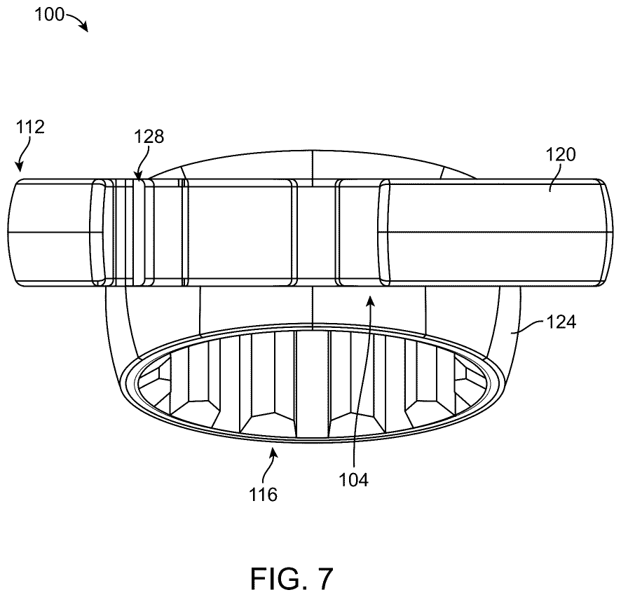

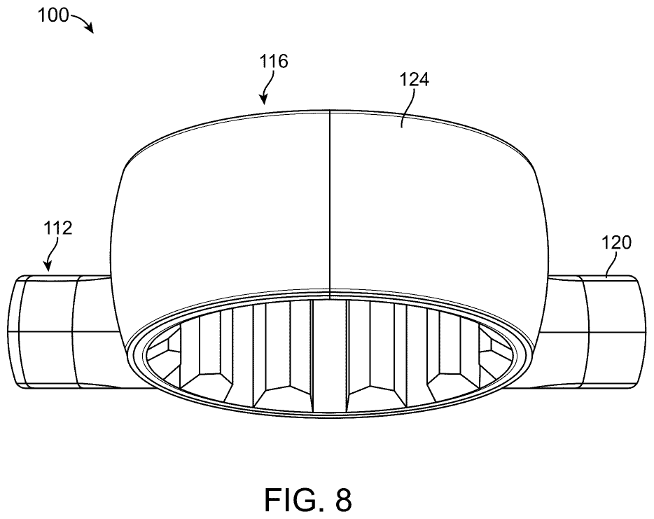

FIGS. 1-8 illustrate a wrench 100 including a body 104 that has a shaft 108, a first head 112, and a second head 116. The shaft 108 extends between the first head 112 and the second head 116. The first head 112 is defined on a first end 120 of the body 104. The second head 116 is defined on a second end 124 of the body 104 that is opposite from the first end 120. In the illustrated example, the wrench 100 is a combination wrench. That is, the first end 120 is an open end and the second end 124 is a box end. In another example, the wrench 100 is open on both ends 120, 124.

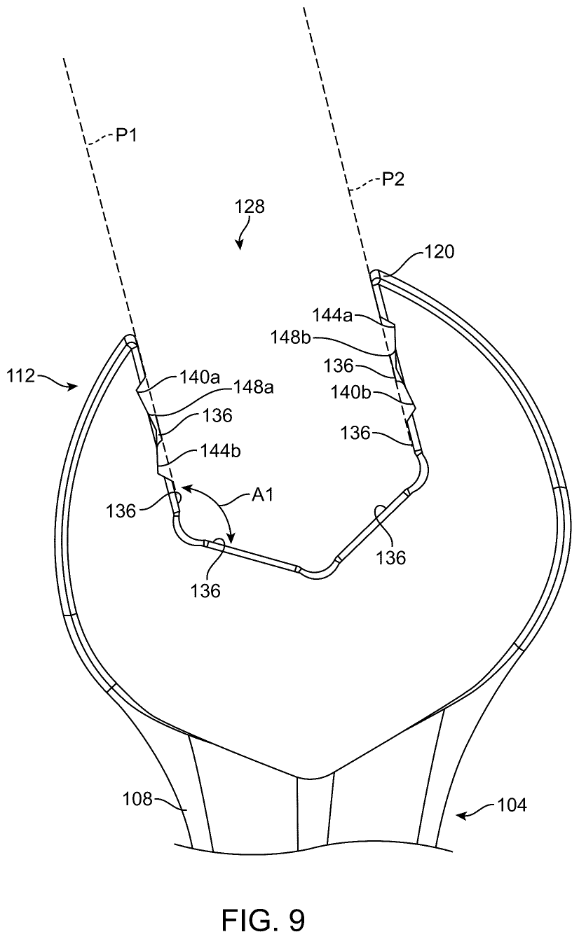

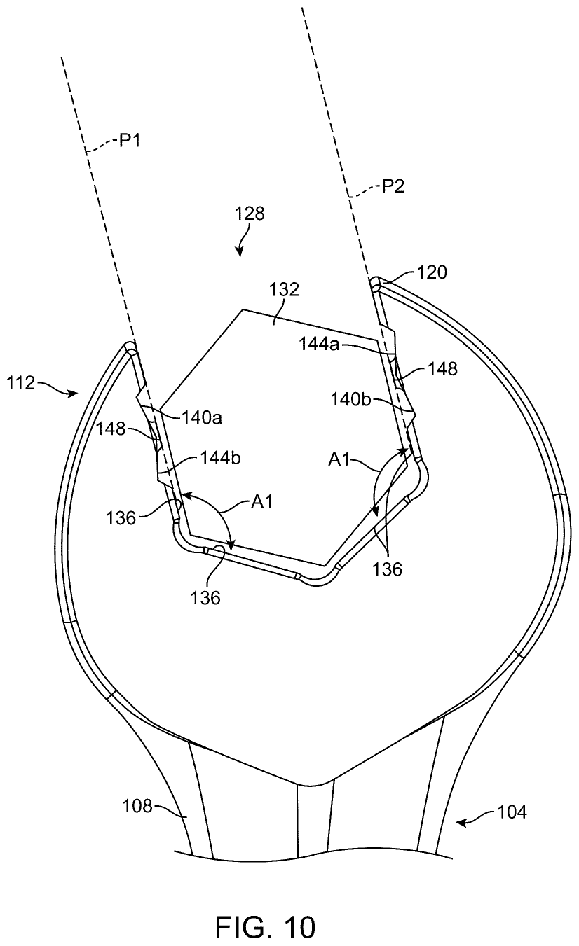

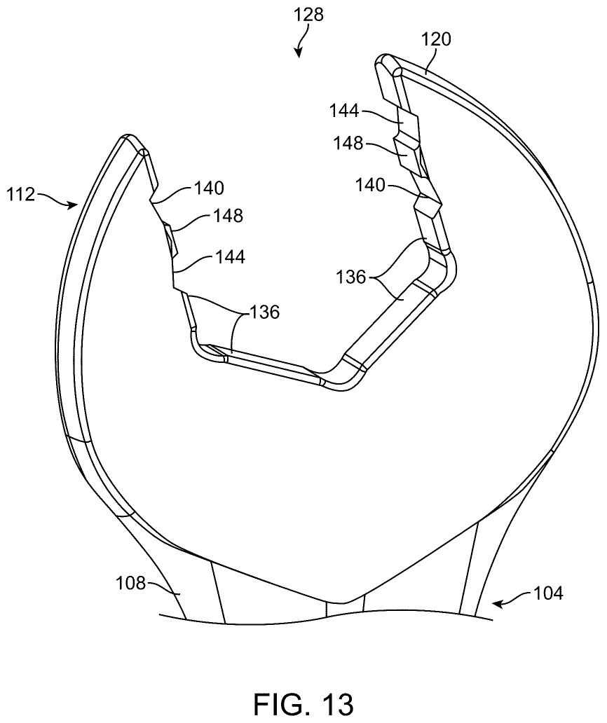

FIGS. 9-13 illustrate the first head 112 including an engagement section 128 that is shaped to engage a nut or a fastener head 132 (each referred to as a “fastener” in the description below) for tightening or loosening the fastener 132. With reference to FIGS. 9 and 10, the engagement section 128 includes standard profile surfaces 136 that define a primary grip structure and that engage the fastener 132 in a standard manner. That is, the primary grip structure engages the fastener 132 as one of ordinary skill would appreciate to turn the fastener 132 (i.e. when there is no slippage of the fastener 132 within the engagement section 128; see FIG. 10). With reference to FIGS. 9-12, the engagement section 128 also includes a first set of surfaces or grooves or teeth 140 and a second set of surfaces or grooves or teeth 144 that selectively engage the fastener 132 when the fastener 132 slips while engaged by the wrench 100. Each of the first set of teeth 140 and the second set of teeth 144 define a secondary grip structure (e.g., a slip-grip structure) that may engage the fastener 132 when the primary grip structure of the wrench 100 slips around the fastener 132. As will be appreciated, the standard profile surfaces 136 and the sets of teeth 140, 144 are structured to engage the fastener 132 in different angular positions. Specifically, the first set of teeth 140 and the second set of teeth 144 engage the fastener 132 in an instance when the standard profile surfaces 136 slip from the fastener 132. Slippage, for example, may occur when the fastener 132 is not fully seated in the engagement section 128 or when excessive force is applied to the wrench.

As illustrated in FIG. 9, the standard profile surfaces 136 are spaced apart on the wall defining the engagement section 128. A first segment of the engagement section 128, defined by different surfaces 136 that are on a plane P1, are oriented at an angle A1 relative to a first base segment of the engagement section 128. The angle A1 is 120 degrees to match the outer surface profile (to match the internal angle) of the fastener 132. Similarly, a second segment of the engagement section 128 defined by different surfaces 136 on a plane P2 are oriented at the angle A1 relative to a second base segment of the engagement section 128 that is adjacent the second segment. In some examples, the angle A1 may be greater than 120 degrees or less than 120 degrees to match the shape of the fastener 132. For instance, the angle A1 may be 90 degrees to match the shape of a square fastener. In some examples, the angle A1 may be in a range of 120 degrees +/−approximately 35 degrees. The plane P2 is parallel or substantially parallel to the plane P1.

As shown in FIG. 9, the first set of teeth 140 includes a first tooth 140a on a first side of the engagement section 128 (adjacent to the opening to the wrench 100 and the plane P1), and a second tooth 140b on the opposite side of the engagement section 128 (adjacent to the second base segment or the back of the engagement section 128. Each tooth 140a, 140b is recessed into the wall defining the engagement section 128 and is defined by a short side surface and a long side surface. The short side surface and the long side surface cooperatively define an angle that is complementary to the shape of the fastener 132 (i.e. to match the profile of the fastener 132). In the illustrated example, the short side surface and the long side surface are arranged at 120 degrees relative to each other. The second set of teeth 144 includes a first tooth 144a on a second side of the engagement section 128 (adjacent to the opening to the wrench 100 and the plane P2), and a second tooth 144b on the opposite side of the engagement section 128 (adjacent to the first base segment or the back of the engagement section 128. Each tooth 144a, 144b is recessed into the wall defining the engagement section and is defined by a short side surface and a long side surface. The short side surface and the long side surface are arranged at 120 degrees relative to each other (i.e. to match the profile of the fastener 132).

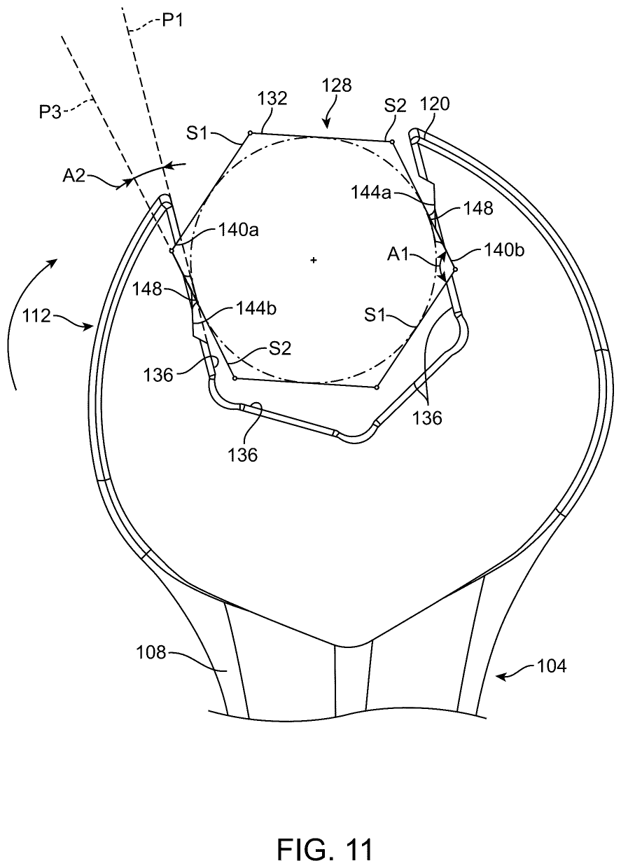

With reference to FIG. 11, the first set of teeth 140 engage the fastener 132 when the fastener 132 slips from engagement with the standard profile surfaces 136 while tightening the fastener 132 (for a right-hand thread arrangement). The first set of teeth 140 are arranged in pairs so that the teeth 140 catch opposite sides of the fastener 132 when slippage occurs between the wrench 100 and the fastener 132. As show in FIG. 11, the fastener 132 has adjacent pairs of sides S1, S2 that engage the opposite teeth 140. The long side of the tooth 140a is on a plane P3 that is angularly offset from the plane P1 at a non-zero angle A2. In the illustrated example, the non-zero angle A2 is approximately 12 degrees. That is, the wrench 100 will rotate 12 degrees after slipping from the fastener 132 before the wrench 100 re-engages the fastener 132 via first set of teeth 140. In other examples, the non-zero angle A2 may exceed or be less than 12 degrees depending on the amount of allowable slip. In some examples, the angle A2 may be in a range of 12 degrees +/−approximately 5 degrees (e.g., less than 20 degrees).

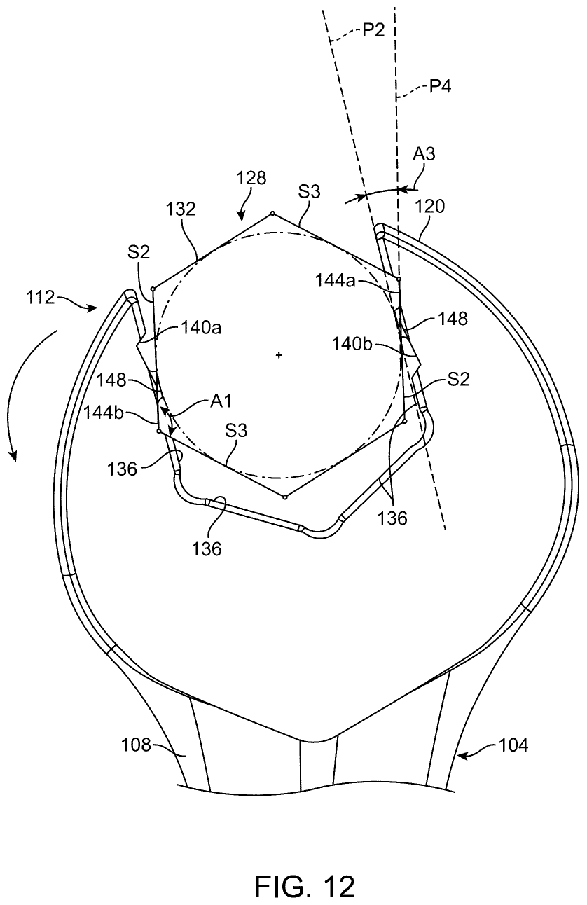

With reference to FIG. 12, the second set of teeth 144 engage the fastener 132 when the fastener 132 slips from engagement with the standard profile surfaces 136 while loosening the fastener 132 (for a right-hand thread arrangement). The teeth 144 are arranged in pairs so that the teeth 144 catch opposite sides of the fastener 132 when slippage occurs between the wrench 100 and the fastener 132. As show in FIG. 12, the fastener 132 has adjacent pairs of sides S2, S3 that engage the opposite teeth 144. The long side of the tooth 144a is on a plane P4 that is angularly offset from the plane P1 at a non-zero angle A3. In the illustrated example, the non-zero angle A3 is approximately 12 degrees. That is, the wrench 100 will rotate 12 degrees after slipping from the fastener 132 before the wrench 100 re-engages the fastener 132 via second set of teeth 144. In other examples, the non-zero angle A3 may exceed or be less than 12 degrees depending on the amount of allowable slip. In some examples, the angle A3 may be in a range of 12 degrees +/−approximately 5 degrees.

With reference to FIGS. 9-13, the engagement section 128 includes a raised portion 148a (e.g., an island) that is disposed between the tooth 140a and the tooth 144b, and another raised portion 148b that is disposed between the tooth 144b and the tooth 140b. That is, the tooth 140a and the tooth 144b are separated by the first island 148a, and the tooth 144a and the tooth 140b are separated by the second island 148a. The long side surfaces of each tooth 140a, 140b, 144a, 144b are located closest to the raised portions 148a, 148b. The raised portions 148a, 148b define some of the standard profile surfaces 136. As best shown in FIGS. 11 and 12, when the fastener 132 is engaged by the first set of teeth 140 or the second set of teeth 144, the portions 148a, 148b act as a backup engagement of the fastener 132 so that, in addition to the teeth 140, 144, the raised portions 148 engage (e.g., bite into) the fastener 132 and prevent slippage of the wrench 100 around the fastener 132 during tightening or loosening of the fastener 132 when the fastener 132 is not fully seated in the engagement section 128 or when the wrench 100 has initially slipped around the fastener 132 during the tightening or loosening process. That is, the teeth 140, 144 are arranged in the engagement section 128 to realign the wrench 100 with the fastener 132 after the wrench 100

initially slips, and the teeth 140, 144 provide enough surface area for high torque applications to continue the tightening or loosening process. With reference to FIGS. 11 and 12, at least a portion

of the raised portions 148a, 148b bite into the fastener 132 to add friction and grip that helps hold the wrench 100 on the fastener 132 after initial slippage. For example, each raised portion 148a, 148b has opposite corners or edges that are adjacent to a corresponding tooth 140, 144. The corner or edge of each raised portion 148a, 148b that is adjacent to the corresponding tooth 140, 144 in

which the fastener 132 is disposed engages and digs or bites into a surface (e.g., surface S2) to firmly hold the wrench 100 on and around the fastener 132. As such, the load is more evenly distributed on the fastener 132. The engagement of the raised portions 148a, 148b with the fastener 132 provides friction and engagement to prevent additional slipping.

Although the invention has been described in detail with reference to certain examples, variations and modifications exist within the scope and spirit of one or more independent aspects of the invention as described. It will be appreciated that each feature of the wrench may form the basis

of one or more claims on its own or in any combination with any other feature or features. The order in which aspects of the wrench are described in no way informs the features, alone or in

combination, that may be novel and inventive. The order that the wrench has been described is only for convenience and should not be construed as limiting regarding what may be claimed.

1. A wrench comprising:
a first end shaped to engage a fastener; and
a second end shaped to engage the fastener,
wherein one or both of the first end and the second end defines an open end of the wrench including an engagement section having a primary grip structure configured to grip the fastener and a secondary grip structure configured to grip the fastener after slippage of the fastener from the primary grip structure.

2. The wrench of claim 1, wherein the primary grip structure includes first profile surfaces shaped to engage the fastener, and the secondary grip structure includes second profile surfaces at least some of which are different from the first profile surfaces.

3. The wrench of claim 2, wherein the second profile surfaces define teeth recessed into the first profile surfaces.

4. The wrench of claim 2, wherein the first profile surfaces define a wall of the engagement section, and wherein the second profile surfaces are defined in the wall.

5. The wrench of claim 2, wherein the secondary grip structure further includes third profile surfaces different from the second profile surfaces and at least some of which are different from the first profile surfaces.

6. The wrench of claim 5, wherein the second profile surfaces include a first tooth defined in one of the first profile surfaces and second tooth defined in another of the first profile surfaces, and wherein the first tooth and the second tooth are on opposite sides of the engagement section.

7. The wrench of claim 1, wherein the primary grip structure is engageable with the fastener in a first angular position of the fastener relative to the open end, and the secondary grip structure is engageable with the fastener in a second angular position of the fastener relative to the open end, and wherein the second angular position is different from the first angular position.

8. A wrench comprising:
a first end shaped to engage a fastener; and
a second end shaped to engage the fastener,
wherein the first end includes an engagement section having first surfaces configured to at least initially grip the fastener, and second surfaces recessed from the first surfaces and configured to grip the fastener after slippage of the fastener within the first end.

9. The wrench of claim 8, wherein the first surfaces are structured to engage the fastener in a first angular position and the second surfaces are structured to engage the fastener in a second angular position different form the first angular position.

10. The wrench of claim 8, wherein a first set of the second surfaces defines a first tooth in the first end, and a second set of the second surfaces defines a second tooth in the first end.

11. The wrench of claim 10, wherein at least one of the first surfaces is disposed on a first side of the first end and another of the first surfaces is disposed on a second side of the first end opposite the first side, and wherein the first tooth is disposed in the first side adjacent to the at least one of the first surfaces and the second tooth is disposed in the second side adjacent to the another of the first surfaces.

12. The wrench of claim 10, wherein each of the first set of the second surfaces and the second set of second surfaces has a short side and a long side.

13. The wrench of claim 12, wherein the short side and the long side cooperatively define an angle complementary to a shape of the fastener.

14. The wrench of claim 12, wherein one of the first surfaces is on a first plane, and wherein the long side is on a second plane that is angularly offset from the first plane at a non-zero angle less than 20 degrees.

15. A wrench comprising:
an open end shaped to engage a fastener, the open end including an engagement section having standard profile surfaces defining a primary grip structure configured to grip the fastener in a first state, the engagement section further having a set of teeth with a first tooth and a second tooth and defining a secondary grip structure configured to grip the fastener in a second state after the fastener has slipped from the first state, and the engagement section further having an island disposed adjacent to the first tooth,
wherein the standard profile surfaces have a first surface and a second surface opposite the first surface and parallel to the first surface, and
wherein the first tooth is disposed in the first surface and the second tooth is disposed in the second surface.

16. The wrench of claim 15, wherein the first tooth is engageable with a first corner of the fastener and the second tooth is engageable with a second corner of the fastener that is opposite the first corner.

17. The wrench of claim 15, wherein the island defines a portion of one of the standard profile surfaces.

18. The wrench of claim 15, wherein the island defines a portion of the primary grip structure and a portion of the secondary grip structure.

19. The wrench of claim 17, wherein the island is a first island and the engagement section has a second island disposed adjacent to the second tooth.

20. The wrench of claim 19, wherein the island is a first island, wherein the set of teeth is a first set of teeth and the engagement section has a second set of teeth, wherein the second set of teeth has a third tooth disposed in the first surface and a fourth tooth disposed in the second surface, and wherein the first tooth and the third tooth are separated by the first island and the second tooth and the fourth tooth are separated by a second island.
